(19) United States
(12) Patent Application Publication
(10) Pub. No.: US 2006/0235800 A1
(43) Pub. Date: Oct. 19, 2006

(54) Digital rights management for media streaming systems

(75) Inventors: Jeff Furlong, Grand Bay - Westfield (CA); Robert Laughlin Cookson, Quispamsis (CA)

Correspondence Address: KRAMER & AMADO, P.C., Suite 240, 1725 Duke Street, Alexandria, VA, 22314, US

(73) Assignee: ALCATEL, Paris (FR)

(21) Appl. No.: 11/107,957

(22) Filed: Apr. 18, 2005

(51) Int. Cl. G06F 17/60

(52) U.S. Cl. 705/59

(57) ABSTRACT

An open media platform (OMP) notifies the subscriber terminals (ST) that the services it provides have changed and that the updated licenses should be retrieved. The STs then initiate a request to a license manager for the new licenses that are required. In response, the license manager requests from the OMP authentication/authorization of the ST and the license terms for the appropriate channels. The OMP authenticates the ST and determines the content ID's associated with the licenses that need to be issued. If authentication is successful, the appropriate C-ID's and terms are returned to the license server. When authorization and the license information are received from the OMP, the license manager generates the personalized licenses and delivers them to the originating ST to enable viewing of the protected content.

### RELATED US PATENT APPLICATIONS

This patent application is related to U.S. patent application entitled “Digital interactive delivery system for TV/multimedia/Internet,” Ser. No. 09/663,973, filed on Sep. 28, 2000, now abandoned in favour of a CIP SN N/A; to U.S. patent application, entitled “Digital interactive delivery system for TV/multimedia/internet with on-demand applications,” Ser. No. 09/676,701 filed on Nov. 29, 2000, both assigned to Alcatel, Inc., and to U.S. patent application entitled “Multicast Distribution Of Streaming Multimedia Content,” Ser. No. 11/037,122, filed on Jan. 19, 2005, which are hereby incorporated herein by reference.

### FIELD OF THE INVENTION

The invention is directed to providing entertainment over communication networks, and in particular to digital rights management (DRM) for media streaming systems.

### BACKGROUND OF THE INVENTION

Use of information technology networks (or communication networks) for distribution of digital assets such as television programming, music, movies, computer programs, pictures, games (collectively referred to as ‘digital content’) continues to gain popularity. This is fuelled by the decreasing cost of equipment and bandwidth to the home, and emergence of interactive personalized services. In order to be able to deliver digital content to users, a content provider must acquire a rental right from the owners of all copyrights covering the respective content. (Copyright is an intellectual property right which enables the owners of an original literary, dramatic, musical works, published editions of works, sound recordings, films and the like to control the way in which their creation/property may be exploited.)

Commercial distribution of digital content enables a content provider (content or rights-owner) to serve a large number of users, thereby increasing the potential revenues to be gained. Typically, a content provider wishes to distribute the digital content to users in exchange for a license fee or some other consideration, and to restrict what the users can do with the distributed digital content. As well, the content providers wish to enable the users with the flexibility to easily purchase different types of licenses at different license fees, while at the same time holding the user to the terms of whatever type of license is in fact purchased. For example, a content provider may wish to allow distributed digital content to be played only a limited number of times, only for a certain total time, only on a certain type of machine, only on a certain type of media player, only by a certain type of user, etc.

As a result, content providers want to express policies by which they require their information to be handled, as well as policies by which the information they receive is handled or processed before it gets to the users. On the other hand, such policies must enable users to readily access the content/assets/events subscribed or purchased, and to readily acquire new offerings of interest as they become available. The subscribers also wish to acquire different types of licenses according to the way they value the respective content/asset/event.

Inherently, the digital content is relatively easy to copy illegally since the distribution channels are insecure. After distribution has occurred, the content provider has very little if any control over the distributed content. This is especially relevant today, when any personal computers includes the software and hardware necessary to make digital copies of large data files, to download the copied file to a magnetic or optical disk, or to send the file copy over Internet to any destination.

Currently, there are two predominant digital content protection models, namely conditional access (CA) and digital rights management (DRM). Conditional access is a technology that is mainly used to control access to digital programming to authorized users by encrypting the transmitted programming. Conditional access has been used for years for pay-per-view broadcasts of live content (e.g., sports events, etc.), which is encrypted and broadcast to end users and selectively decrypted at the end user's site using a set-top box.

Digital Rights Management technology focuses on making difficult, if not practically impossible, illegal use of digital content. A DRM system deals with intellectual property rights specification, verification, management and enforcement, and particularly with electronic copyright management, and also with authentication, authorization, accounting, payment and financial clearing, and document protection.

A number of companies are providing assorted DRM turnkey packages based on a variety of approaches and technologies. For example, DRM packages include server software, specialized client applications, user plug-ins for web browsers, and media players such as Apple QuickTime and Microsoft Media Player. Available DRM technologies include Electronic Media Management System (EMMS) from IBM, A2B from AT&T, Liquid Audio Pro from Liquid Audio Pro Corp., City Music Network from Audio Soft, InterTrust DRM, ContentGuard, EMediator DRM, from MediaDNA, Vyou.com and many others.

Many DRM systems based on license distribution are applicable to broadcast IPTV (IP Television, which is a term used to describe service offerings for the delivery of packetized video over a broadband network), such as NDS, Widevine. However, Microsoft's DRM solution (Microsoft® Windows Media® Rights Manager) is preferred for broadcast and VoD content protection, because it enables secure distribution of digital media, provides flexible business models and is a highly scalable platform. In addition, support for Windows Media Rights Manager is widespread (over 450, 000 installed players) ensuring broad compatibility. Information about the features and operation of this platform could be found at: http://www.microsoft.com/windows/windowsmedia/drm.aspx

On the other hand, Windows Media Rights Manager is not suitable for broadcast IPTV, since it was originally developed for unicast content from the Internet. As such, it permits license distribution via HTTP. In addition, today, the licenses for the digital content are managed at the user level. As well, the current license distribution methods require a separate license for every content file (stream).

It is therefore desirable to design a multimedia distribution system with an architecture that allows controlled download and play of digital content, where such control is flexible and definable by the content provider in agreement with the user. Such architecture needs to enable content delivery as specified by the content provider, even though the digital content is to be delivered to a user terminal which is not under the direct control of the provider. It is also desirable to provide an improved mechanism for enabling management of digital rights to the content so that the content provider can continue to effectively restrict the use of the content subsequent to transferring the content to the user.

### SUMMARY OF THE INVENTION

It is an object of the invention to provide a digital rights management (DRM) system and method that alleviates totally or in part the drawbacks of the prior art DRM systems.

It is another object of the invention to provide a DRM system and method that enables a content provider to deliver digital content securely to a user, and for managing the digital rights to the content so that the content provider can continue to effectively restrict the use of the content subsequent to transferring the content to the user.

Accordingly the invention provides a method of enabling fast access of the subscriber terminals to a license-protected broadcast channel subscribed for, in a broadcast entertainment system equipped with a license manager for storing generic broadcast licenses, and provided with a open media platform (OMP) serving a plurality of subscriber terminals. The method comprises: a) maintaining at the OMP a directory with license information specific to each subscriber terminal (ST served by the OMP; b) on request from a subscriber terminal (ST) to access the license-protected broadcast channel, providing the license manager with the license information for that ST and that channel for enabling the license manager to generate a personalized broadcast license; c) storing and maintaining at the subscriber terminal, the personalized broadcast license; and d) decoding the multimedia content carried on the license-protected broadcast channel using the personalized broadcast license, whenever the subscriber terminal requests access to the license-protected broadcast channel, wherein the personalized broadcast license includes subscription details for the subscriber terminal.

According to another aspect, the invention provides an open media platform (OMP) for a broadcast entertainment system equipped with a license manager for storing generic broadcast licenses, the OMP for serving a group of subscriber terminals in a geographical area, comprising: means for transmitting a license-protected broadcast channel subscribed for by one or more subscriber terminals of the group; a license task for receiving from a license manager an authorization/authentication request specifying that a subscriber terminal wishes to receive the license-protected broadcast channel, and for providing the license manager with the license information for the respective authorization/authentication request; and a directory with license information specific to each subscriber terminal served by the OMP.

Still further, the invention provides, for a broadcast entertainment system equipped with a license manager for storing generic broadcast licenses, and with an open media platform (OMP) for serving a group of subscriber terminals in a geographical area, a subscriber terminal comprising: a decoder for decoding encoded multimedia content received over a set of broadcast channels subscribed for by the subscriber terminal; a subscriber terminal .nsc process for processing a plurality of locally stored .nsc files, each .nsc file comprising information necessary for accessing and playing a respective broadcast channel of the set; a subscriber terminal license process for receiving a personalized broadcast license and using same for decoding encoded multimedia content carried on the respective broadcast channel; a license memory for storing the personalized broadcast license; and a ST interface for transmitting a request for the personalized broadcast license to the license manager and receiving the personalized broadcast license from the license manager.

Advantageously, the system and method according of the invention enables delivery and distribution of broadcast licenses to the user terminals while limiting the scalability and latency issues introduced when retrieving the licenses via HTTP from a server.

The pre-delivery of broadcast licenses based on package subscriptions allows the license to be local on the STB when the channel tune takes place instead of retrieving the license just-in-time which will introduce latency to the channel tune process. Storing the licences in persistent memory on the STB eliminates the requirement for server access (HTTP) each time the STB is tuned to a new channel which provides for a scalable approach to broadcast license delivery using MS-DRM.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates the block diagram of a multimedia distribution system incorporating the present invention;

FIGS. 2a and 2b illustrate options for distribution of new licenses to allow users to view digital content, where FIG. 2a shows pre-delivery of broadcast licenses, and FIG. 2b shows delivery of broadcast licenses on initial access to protected content;

FIG. 3 illustrates a channel tune operation for joining/leaving license-protected broadcast channel(s);

FIG. 4 illustrates how all valid licenses for a certain user are re-issued on request;

FIGS. 5a-5c illustrate options for caching licenses, where FIG. 6a shows how to cache licenses using flash memory at the subscriber terminal, FIG. 6b shows how licenses are cached using the network file system (NFS), and FIG. 5c shows how licenses are cached using the Hypertext Transfer Protocol (HTTP); and

FIG. 6 illustrates how licenses are retrieved on boot.

### DETAILED DESCRIPTION

The present invention provides a solution for granting and distribution of licenses to user terminals for viewing of multicast streams requiring a license. This solution applies for example to distribution of digital content using Microsoft Windows Media streaming systems, or other compatible systems. Explanation of some terms pertinent to these systems is provided next for better understanding of this invention.

Video streaming is achieved by multiplexing and synchronizing coded video, audio and text (multimedia) into a single bit stream or multiple bit streams for transmission or storage purposes. Streaming enables real-time delivery of the content, since the content of the stream can be played while still in the process of being downloaded. To view the content, the user's browser opens player software, which buffers the file for a few seconds and then plays the file while simultaneously downloading it. Streaming media files are not stored locally on a user terminal; typically the parts of the content are discarded once used (viewed). Streaming media formats used today include for example RealNetworks RealSystem G2, Microsoft Windows Media Technologies (“WMT”), and Apple Quick Time.

Microsoft's Windows Media 9 (WM9) is a de/compression application used by the entertainment industry for streaming multimedia platforms. VC-1, the new name for Windows Media 9 has just moved from Committee Draft to Final Committee Draft stage in the Society of Motion Picture and Television Engineers (SMPTE) standardization process. The major High Definition DVD formats are now able to play VC-1, aka WM9 content. WM9 streaming systems make use of a file format known as ASF (Advanced Streaming Format). An ASF file container stores audio, multi-bit-rate video, metadata such as title and author, and index and script commands, such as Universal Resource Locators (URLs) and closed captioning. Audio and video content compressed with a wide variety of codecs (coding/decoding devices) can be stored in an ASF file and played back with a Windows Media Player, provided appropriate codecs are installed on the user terminal.

ASF provides for segmentation of the multimedia streams into individual data packets, multiplexes the packets, and time synchronizes the streams as required for presentation. A header, known as an ASF header, is placed at the beginning of the file, and contains important information required to decode the stream. Thus, the header provides means of identifying individual component streams and the packets which belong to these streams; information on the video codec configuration (e.g. WM9) required for initializing the video decoder; information on the audio codec configuration required in order to initialize the audio decoder, and the DRM (Digital Rights Management) information required to acquire licenses and decrypt the stream.

However, unlike a unicast stream, no header information is contained in a multicast stream, since the multicast stream is continuous and must support random access. In order to address this problem, multicast distribution of the information in the ASF header is currently obtained through an alternative mechanism known as a Windows Media Station file, or an .nsc file. A .nsc file contains in addition to the information in the ASF header, information specific for connecting and playing a multicast stream, such as the multicast IP group address, multicast port, stream format, and various station settings. A Windows Media Player usually opens an announcement file first, that points it to the location of the .nsc file.

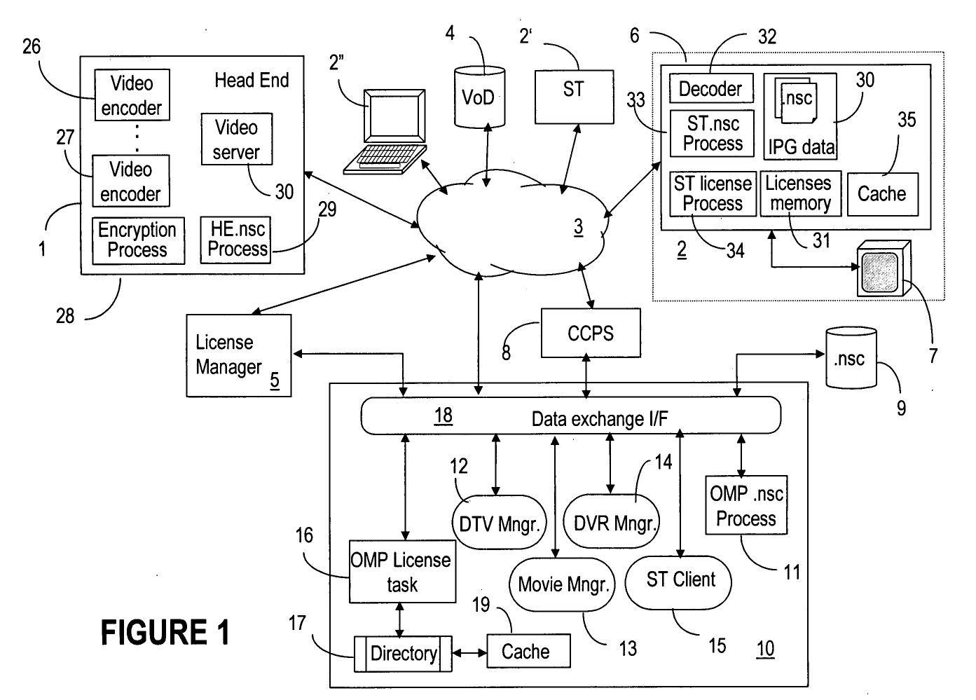

FIG. 1 shows the block diagram of a multimedia distribution system incorporating the present invention. The architecture of FIG. 1 comprises a head end 1 serving a plurality of subscriber terminals 2, 2’, 2′ a DRM (digital rights management) server 5, a License Manager 5 and an open media platform (OMP) 10, connected over a broadband IP network 3. The platform 10 is also referred in the following as ‘media manager (MM)’ or ‘middleware platform’.

The head end 1 is shown schematically as including a plurality of video encoders 26, 27, which provide for live and off-line encoding of audio and/or video services. These encoders are enabled with multicast services, and are directly managed by a video server 30. For example, encoders 26, 27 may be Windows Media 9 Encoders, and server 30 may be a Windows Server running Windows Media Services.

The transport and access network 3 provides the infrastructure that links the head end 1, License manager 5, VoD servers 4, and OMP (open media platform) 10 with the video decoders on clients 2, 2‘, 2′. Network 3 includes all routers, switches, long haul and metropolitan transport and access systems necessary for transporting the video streams and the associated management and license data. Thus, network 3 supports transport of video-on-IP unicast and multicast content, and could be IP router and switch based, where IP multicast replication is accomplished by core and edge routers.

The edge routers of network 3 are provided for example with IGMP (Internet Group Management Protocol) to enable IGMP switching for IP multicasts, broadcast television and special IP multicast information. QoS for subscriber services is implemented using IP queuing in the edge routers. The edge routers may also be enabled with static routing of most popular broadcast channels to improve channel change times.

Preferably, a unique VLAN is assigned to each subscriber to provide a level of security against IP spoofing. Subscriber VLANs could be aggregated at the edge routers on both ATM and Gigabit Ethernet interfaces depending on the type of connected DSLAM (digital subscriber line access multiplexer). A single permanent virtual channel (PVC) is provisioned on each DSL (digital subscriber line) port, for use by all available services, such as broadcast TV (BTV), Video-on-Demand (VoD), high speed Internet (HSI), etc.

Video-on-Demand (VoD) services preferably follow a distributed architecture with multiple servers 4 carrying the newest and most popular content at points of presence which are close to the network edge. The .nsc server 9 shows generically the storage for the .nsc files necessary for enabling the clients of media manager 10 to view the content provided by platform 10. However, the present invention is concerned with broadcast licenses, i.e. licenses needed for viewing broadcast channels, rather than to VoD licenses. The VoD services are discussed tangentially only.

Preferably, the License manager 5 maintains information required to acquire licenses and decrypt the respective digital content stream for protecting the rights of content owners. The License manager 5 provides secure distribution of digital content, in a protected, encrypted file format through secure cryptographic protocols, while enabling the customers to obtain digital content easily and legitimately.

The license manager 5 may for example be a Windows Media Rights Manager™, which “locks” the digital content files with a license key for content protection, even if these files are widely distributed. Each license is uniquely assigned to each terminal; with individualization, any compromised player can be identified and disabled during the licensing process, so that the compromised player cannot be widely distributed over the Internet. License manager 5 also ensures content protection in the operating system on the user's terminal for reducing the likelihood that any unauthorized program will capture a digital media stream within a terminal, enables revocation of compromised players and ensures broad compatibility with a very large number and type of subscriber terminals. In the embodiment illustrated in FIG. 1, the license manager 5 also includes a DRM server for storing the licenses, and the interfaces with the clients 2 and the OMP 10.

The subscriber terminals (ST) 2, 2’, 2′ also referred to as user terminals, subscriber device, clients or users are “IP enabled”. As also seen in FIG. 1, a subscriber terminal 2 may be provided as a separate set-top box (STB) 6 with a TV 7 and a video player integrated into the TV or STB or not, as shown for ST 2, or may an integral part of a personal computer, or an integral part of any data device equipped with a display enabled to receive, decode and play the digital content.

As indicated above, a single PVC (permanent virtual connection) may be used on each DSL port, and the OMP may also be connected to a DSL port. DHCP (Dynamic Host Configuration Protocol) is used for IP address assignment for both the STB and subscriber PCs (Personal Computers); for example private IP addresses are assigned to STBs, while public addresses are assigned to PCs. IP unicast and User Datagram Protocol (UDP) is used to transport VoD from the servers to the terminals 2. Such an IP terminal enables operational teams to remotely activate and deactivate services, perform upgrades, diagnosing and troubleshooting from a network operation center.

A ST includes generically the hardware (HW) and software (SW) provided for enabling the respective subscriber to join multimedia streams multicast over network 3 for viewing digital content/assets/events of interest. FIG. 1 shows the components of the ST that are relevant to this invention. It is to be understood that the ensuing description is provided for IPTV multicast systems that use ASF; other systems may be equally used without departing from the scope of this invention. In FIG. 1, the IP based subscriber devices 2, 2’, 2′ comprise a decoder 32 for playing back digital content (i.e. the codec for decoding the video content) and other general purpose applications (not shown) such as the device operating system, a video support system, the HW and SW for supporting high picture quality, SDTV/HDTV, etc, a web browser, a network interface and a subscriber interface. The video content is retrieved over network 3 from various sources, as discussed above, using preferably the ASF format.

As described in the above-mentioned patent application Ser. No. 11/037,122, user terminals 2 store locally the .nsc files for enabling the user to join/leave the channels in its channel line-up, so that the terminals do not have to access server 9 every time a respective subscriber changes a channel. Delivery and distribution of .nsc files to the users is performed by OMP 10 using a multicast broadcast solution. This functionality is generically shown by a ST .nsc process 33 used for retrieving the .nsc files, storing them locally, in a local memory 30, and using them as needed. The ST's also store locally on memory 30 interactive program guide (IPG) data with personalized information necessary for accessing and playing a respective broadcast channel.

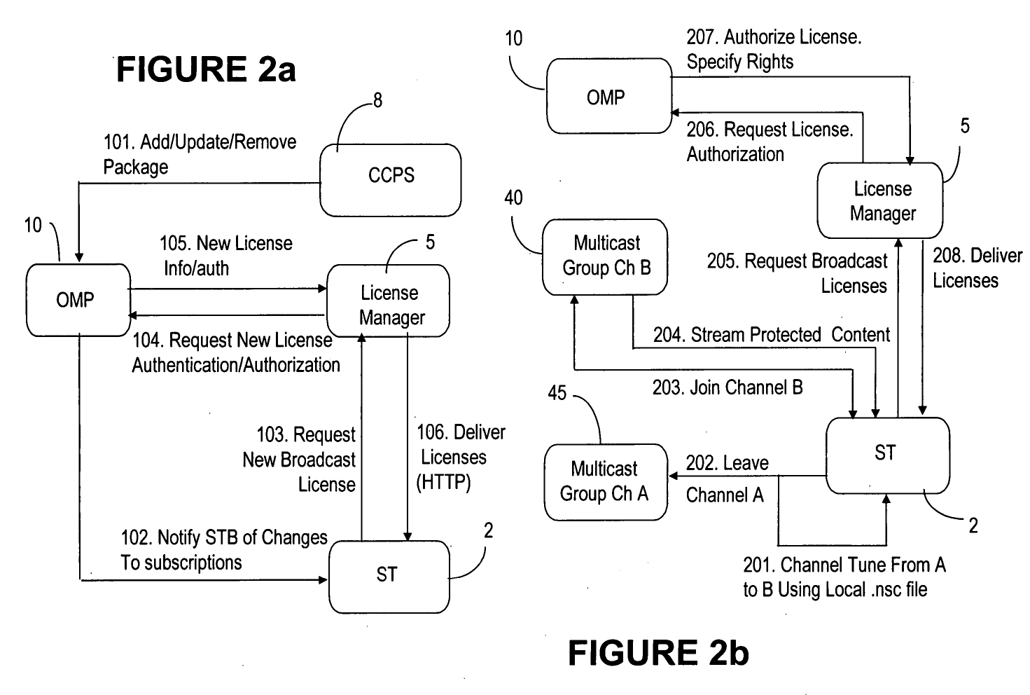

STs 2 are also provided with a ST license process 34 triggers a request (this description uses the term “client request”) receive a new broadcast license from the license manager, and upon retrieving the licenses from license manager 5, stores it locally as shown at 31. ST license process may also issue a request for all broadcast valid licenses for that client on ST initialization (details provided in connection with FIGS. 2a, 2b). As all valid licenses for the respective client are stored locally in license memory 31, the terminals can access the licenses fast for viewing the license protected content/assets/events. Process 34 also enables caching the licenses.

Platform 10 is provided with a view to improve the overall latency and scalability of the multicast distribution system. While it simplifies the head-end, OMP 10 enables content providers to create highly competitive multi-media entertainment services, designed for their market and their customers'demands, such as unlimited channels of digital TV, Video on Demand, Personal Video Recorder, Pay Per View, Electronic Program Guides, and other rich content services. Using industry standard technology, and based on demand for new services from the users of the OMP, service providers can take advantage of HTML, Java Server Pages (JSPs) and custom JSP Tag libraries and XML interfaces to extend or create new applications by extending the capabilities of OMP 10 as needed.

FIG. 1 shows only the components of OMP 10 relevant to the invention. OMP 10 includes a DTV (digital TV) manager 12, a movie manager 13 and a DVR manager 14. DTV manager 12 contains server-side tools to manage business operations and client-side features such as broadcast television, Interactive Program Guides, Pay-Per-View, Parental Control, and integrated Web browsing. Movie Manager 13 allows service provider to build an on-demand service for customers to preview, purchase, and play on demand content. Service providers decide how users access on demand content and design the look and feel of user interfaces. DVR (digital video recorder) manager 14 enables time-shifted viewing of broadcast programs, allowing customers to record and watch programs at their convenience. DVR manager uses preferably network servers to store content.

Platform 10 maintains the .nsc files 9 for all content files that it may provide to users and multicasts the set of broadcast channels subscribed for by one or more subscriber devices. An OMP .nsc process 11 is used for retrieving broadcast .nsc files from the head-end 1 and multicasting these files to the STs. Process 11 provides effective and scalable announcements of new multicast services (channels) available to terminals 2, 2’, 2” managed by the middleware platform. These announcements are multicast in the form of a multicast notifier; a user terminal processes the notifiers addressed to it and joins a respective channel data multicast group of interest based on the multicast address provided by the notifier. The terminal then retrieves the IPG and channel data, including the .nsc information.

The term “authentication/authorization request” is used in this description for a demand triggered by the license manager 5 to requesting platform 10 to verify the validity of the client request. The term “license information” refers to the terms (rights) of the respective license that the client wishes to purchase and the channel line-up for that client. For example, the license terms may limit view of a channel for a certain period of time (start/end date), or for a certain total time, a maximum number of times, on a specified terminal in the respective household, etc, based on the respective subscription. The term “license authorization” refers to the authorization given by the OMP to license manager to generate a license based on the license information and deliver it to the respective client (subscriber terminal). In principle, transmission of the license information to the license manager implies that the OMP authorizes the client to view the requested channel (i.e. a license should be granted).

According to the present invention, platform 10 includes an OMP license task 16 in charge with authorizing, servicing and personalizing broadcast licenses for user terminals, with a view to enable viewing of multicast streams acquired by the respective clients. The license task 16 interfaces with the license manager 5 for receiving authentication/authorization requests, determining the rights of the respective clients and transmitting the license information to the license manager 5. FIG. 1 also shows a subscriber directory 17 maintained by OMP 10, which maintains subscriber information with the license information accorded to each subscriber device for which digital content.

A ST client application 15 interfaces with all clients of the OMP 10. The ST client 15 notifies the appropriate (affected) subscriber devices 2 whenever the respective license information has changed and that updates should be retrieved. This message may use for example SNMP to trigger a client request to the license manager. The license manager 5 receives the clients requests, requests authorization/authentication from OMP 10, and if the request is valid, generates the appropriate license(s) and sends the license to the subscriber terminal which has been waiting since it lodged the request.

The directory 17 maintains client information related to licenses; the clients are identified with a subscriber ID, which is based on the unique IP address. For example, the client ID may be a combination of the terminal MAC address and some random numbers. The content/asset/event for which a license is sought is uniquely identified by a content or channel ID, so that it can be referenced for authorization of the license for protected broadcast content. The content ID is created from the content header and it is included in the .nsc files created by encoders 26, 27 at the head-end. This content ID may for example originate from the license manager 5 and be passed to the encoders; other arrangements are equally possible. The license information is identified by a licence ID.

FIG. 1 also shows a customer care provisioning system (CCPS) 8 used by a service provider for managing clients account, information and services. CCPS 8 may be integrated on the middleware platform 10, or provided at a location in the network. If CCPS is an independent entity, OMP preferably provides an XML interface that enables IPTV services for customers to be automatically provisioned from the customer care system 8. For example, the packages/subscriptions for broadcast TV are provisioned in the customer care system 8 and automatically provisioned in OMP to make them available to the subscriber.

The OMP 10 uses data exchange interfaces 18 for communicating with all entities of the multimedia distribution system. FIG. 1 shows this as a single interface for simplification; it is to be noted that various entities communicate over this interface using various protocols. For example, the interface with customer support application 35 may use XML (Extensible Markup Language), which is a simple dialect of SGML suitable for use on the World-Wide Web for creation of custom markup languages such as the Windows Media Player skin definition language). The interface with the server 5 may use HTTP (Hypertext transfer protocol), and the interface with the STs may use HTTP or SNMP(Simple Network Management Protocol).

FIGS. 2a and 2b illustrate options for distribution of new licenses to allow users to view broadcast digital content. FIG. 2a shows pre-delivery of the broadcast licenses option, i.e. pre-delivery of licenses for decoding (decrypting) broadcast content such as TV channels upon registration of a subscriber or when subscription changes are made.

As illustrated at step 101, broadcast license packages are provided by the customer care system 8 to OMP 10 across data exchange interface 18. These broadcast packages may indicate adding, updating or removing of services for subscribers to OMP 10. In step 102, the OMP 10 notifies subscriber devices 2 affected by the consumer subscription information change that updates should be retrieved. This message may use for example SNMP. All affected STs 2 then initiate in step 103 a request to the license manager 5 for the new licenses if the message advises such a requirement; this request could be for example a background HTTP request. To make the process more efficient, only one client request is made but multiple licenses, if appropriate, are to be issued for the newly provisioned channels. The unique ID of the subscriber device 2 and the content ID are included in the request.

Upon receiving the request, the license manager 5 authenticates the request based on the subscriber device ID, the request type and the rights of the subscriber to view the respective content. The license manager 5 passes the subscriber device ID and the license request type to OMP 10, step 104. On receipt of the subscriber device ID and license request type from the License manager, OMP 10 compares the last successful request date-time with the current request date-time. As a result, OMP 10 determines the digital content/channel ID associated with the license(s) that need to be issued and authorizes the License manager 5 to deliver the license to the respective subscriber. If authentication is successful, the appropriate content/channel IDs and rights (e.g. begin date, expiration date) are returned to the license manager, step 105.

When authorization and the license info are received from OMP 10, the license manager 5 grants the appropriate licenses based on the content ID and the respective user ID from directory 17 and also based on the license information (rights) returned form OMP 10. The broadcast licenses are then delivered to the originating subscriber device 2, as shown in step 106, to enable viewing of the protected content.

FIG. 2a shows a scenario whereby the licenses for broadcast content are created and distributed on initial registration of a user terminal, or on boot-up. This mode of operation may result in additional time to boot the terminals 2. This situation is addressed by issuing licenses for packages, resulting in less licenses. The licenses may also be cached for reducing the time to boot, as seen later. In addition, the licenses are stored locally at 31 after the initial registration, so they can be retrieved on boot-up without going through the process of requesting, issuing and distributing the licenses. Only the changes are distributed to the STs.

FIG. 2b shows delivery of broadcast licenses on initial access to protected content option. This requires that a license be requested, issued and distributed before a channel tune is completed. In the example of FIG. 2b, a user currently watching a channel A wishes to switch on channel B to view the license-protected content streamed on channel B. As shown by step 201, the respective subscriber device 2 tunes to channel B which is included in a multicast group 40, from channel A which is included in a multicast group 45. The local .nsc file at 30 is used by terminal 2 to determine how to leave the appropriate multicast groups 45.

Terminal 2 uses the appropriate .nsc file to leave channel A, step 202, and uses the appropriate .nsc file join the new channel, which is channel B in this example, as shown in step 203. OMP may apply at this point business rules for parental control, subscribed/unsubscribed, etc. If valid, the channel tune process continues. Once the join operation has been performed (i.e. ST 2 receive the multicast address from where to receive channel B), the multicast group channel B streams the protected digital content to the respective terminal 2, as shown in step 204. On receipt of the digital content, terminal 2 determines that the content is license-protected, and checks locally for a valid license. If the appropriate license exists in memory 31, the content streamed on channel B is decrypted and the user can view it. If a license for the protected content streamed on channel B is not in the local memory 31, ST 2 issues a client request for the respective broadcast license to license manager 5. For example, ST 2 may use a License Acquisition URL (Universal Resource Locator), which is included in the local .nsc file at 30 for the content on channel B. This request is received by the license manager 5, as shown in step 205. Upon receiving the client request, the license manager requests from OMP 10 authentication/authorization of the subscriber for the package/channel being requested, step 206. As in the scenario described in FIG. 2a, license manager 5 passes the client ID (IP address of the respective terminal 2) and the content/channel ID of the specified content to OMP. OMP 5 receives the request and uses the terminal's IP address to authenticate the subscriber and the content/channel ID to authorise that this terminal has a valid subscription for the respective content from directory 17. If authentication is successful, the request is authorized against the subscriptions/purchases of the subscriber. If the content has been purchased, an authorization of the license request is returned to the License manager, along with the rights to be used in generating the license, step 207. When authorization is received from OMP 10, the license manager 5 generates and delivers the appropriate licenses to the terminal, shown in step 208.

The scenario described in connection with FIG. 2b introduces latency to the channel tune process on the first time that a channel is tuned, each time after a terminal boots. Subsequent channel tunes to protected content could then access the license that is stored locally at 31, with practically no latency. Nonetheless, pre-delivery of broadcast licenses shown and discussed in connection with FIG. 2a is preferred over the scenario of FIG. 2b as it does not introduce an unacceptable latency in channel tuning and it can be optimized through license caching, as seen later.

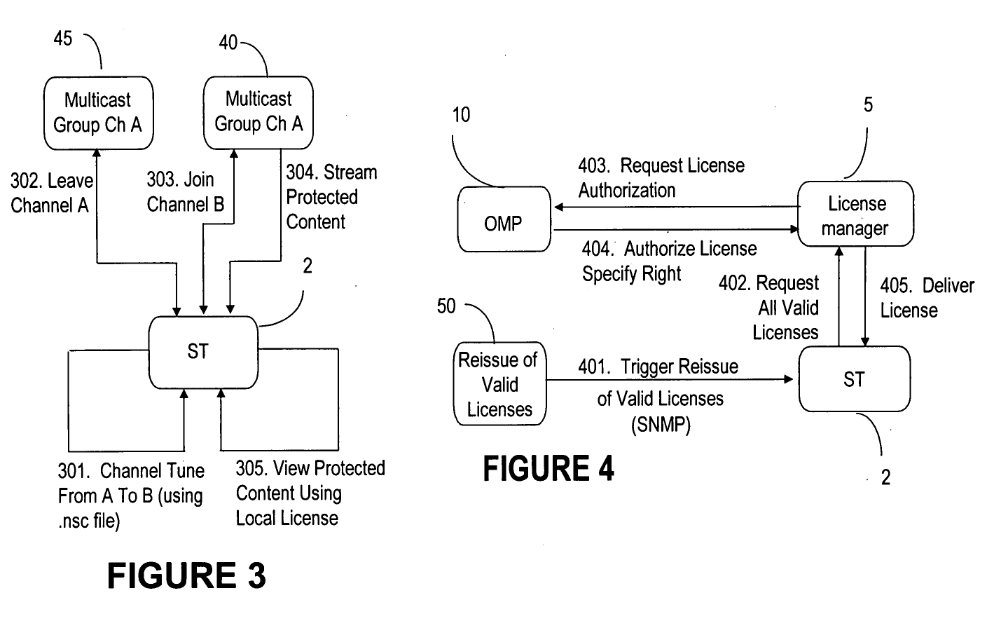

FIG. 3 illustrates a channel tune operation for joining/leaving license-protected broadcast channels. Tuning to multicast channels for leave/join of appropriate multicast groups requires use of the respective .nsc files, as explained above. This scenario assumes that the appropriate .nsc files have been previously delivered and are stored for local access by the respective terminal 2 at 30. This scenario also assumes that the appropriate license files have been previously delivered and are stored for local access by the respective terminal 2 at 31. By maintaining the current valid licenses and .nsc files for the respective user at the user terminal, this approach eliminates the requirement to retrieve these files as part of the channel tune process and minimizes the latency introduced.

In the example of FIG. 3, the subscriber currently watching the content streamed on a channel A wishes to switch to a license-protected channel B. As shown in step 301, the subscriber terminal 2 tunes to channel B from channel A. The terminal uses the appropriate .nsc file in local memory 30 to leave current channel (channel A), step 302, and uses the appropriate .nsc file in local memory 30 to join the new channel (channel B), step 303. OMP 10 first applies the business rules for channel B (if any) and determines if the channel is subscribed for by the respective user. If valid, the channel tune process continues. The terminal 2 also determines that the content is protected and checks locally for a valid license, step 304. The license -that was previously delivered is used to view the content, step 305.

An additional operational capability may be required, whereby a ST 2 requests that all its valid licenses be re-issued. This operation may be necessary if up-to-date license cache files are not available on ST boot due to a failure or in some other exception situation. This capability could also serve as a reset for ST licenses. Depending on the number of licenses requested, this could generate load on the license server but this operation is only performed in exception situations. FIG. 4 illustrates how all valid licenses for a certain user are re-issued on request. In this example, an external process 50, possible manual, issues an SNMP message to the ST 2 for initiating a request for all valid licenses to be re-issued to the respective terminal, step 401. The ST 2 initiates a request to the License manager 5 for all valid licenses, step 402. The unique ID of the device as well as the request type is included in the request.

Upon receiving the license request, the license manager 5 passes the unique ID of the ST and the license request type to media manager OMP 10 and requests OMP 10 authenticate/authorize the ST and the content ID of the appropriate channels, step 403. The OMP receives the request, authenticates the ST and determines the content/channel ID's that the subscriber has a right to. OMP returns the appropriate license information for the respective content/channel ID's to the license manager, step 404. When authorization and the license information is received from OMP 10, the license manager 5 generates the appropriate licenses and delivers them to the originating client to enable viewing of the protected content, step 405. With this scenario, the client may re-fresh also all its VoD and PPV purchases.

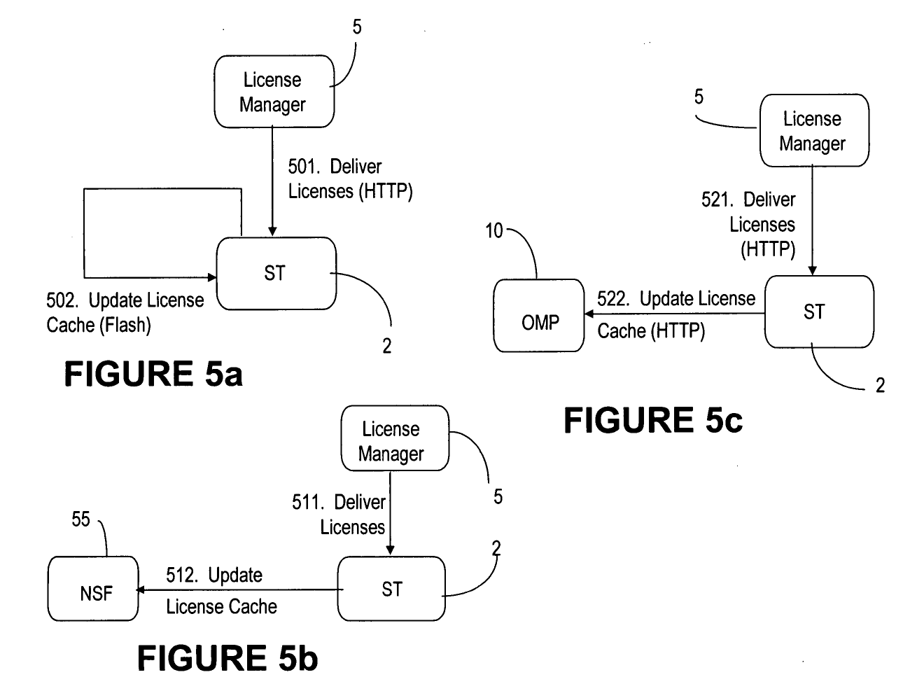

As described and illustrated in FIGS. 2a and 2b, the licenses are persistently stored locally in memory 31 (rather than on license manager 5) to avoid the necessity to re-issue all licenses every time a ST boots-up or accesses license-protected content. FIGS. 5a-5c illustrates some options for caching licenses to address the scalability impact of re-issuing licenses each time a terminal boots as per the scenario of FIG. 2a. FIG. 5a shows how to cache licenses in a flash memory 35 available at the ST 2. The caching of the license files must be initiated from the ST. When new licenses (broadcast, VoD, or PPV) are delivered to the ST 2, a background update of the flash license cache is initiated, as shown in step 501. The ST 2 updates the license file stored persistently in memory 31 on ST 2, step 502. This file is available to the video player after subsequent ST boots.

In the example shown in FIG. 5b, the licenses are stored in the file system 55 maintained by the OMP 10, and the OMP is also provided with a cache 19. In this scenario, the caching of license files must be initiated from the ST, as shown in step 511. When new licenses are delivered to a ST 2, a background update of the license cache 19 is initiated, whereby the ST 2 copies the updated license file to cache 19, step 512. This file will be retrieved with other consumer specific information on STB boot. Since the size of the licenses is relatively small, the increased load on the file system 55 is minimal.

FIG. 5c shows how licenses are cached using the Hypertext Transfer Protocol (HTTP) to transfer the license files between the ST 2 and OMP 10. As seen in this figure, when new licenses are delivered to a ST 2, a background update of the license cache in the OMP directory 17 is initiated, step 521. The ST client copies the updated license file to OMP 10, step 522. This file will be retrieved with other consumer specific information on STB boot. This option eliminates potential compatibility/licensing issues between the ST and file system 55 by using HTTP.

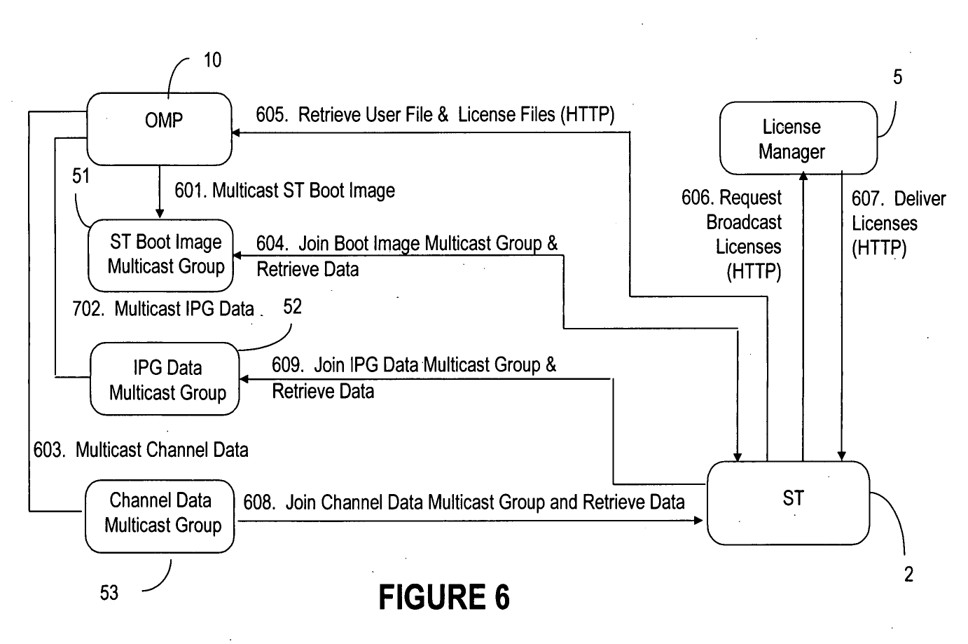

Since it reduces the possible scalability and performance issues introduced by the options shown in FIG. 6b and 6c, caching licenses in ST flash 35 as shown in FIG. 5a is the recommended approach. This option also eliminates potential compatibility/licensing issues between STs 2 and file system 55.

The licenses must be retrieved by the terminals on each boot-up subsequent to allow access to protected content. FIG. 6 illustrates how licenses are retrieved on boot-up. OMP 10 multicasts the boot image of the ST to be retrieved by the ST on boot-up, step 601. On boot-up, OMP 10 multicasts the IPG data to be retrieved by the ST, step 602, and also multicasts the channel data to be retrieved by the ST 2, step 603. On boot-up, the ST 2 joins the boot image multicast group 51 to retrieve the boot image, step 604, and retrieves the consumer specific files from media manager 10 (using e.g. HTTP), step 605. At this time, ST 2 also retrieves the license files that have been cached as licenses have been issued over time.

If this is the initial boot of the respective ST 2 (registration), the ST will request that all valid broadcast licenses be issued based on the consumer's subscriptions, step 606.

The ST initiates a background licence request to the license manager 5 for all valid licenses, step 607. The request includes the unique ID of the device as well as the request type (broadcast licenses). Upon receiving the license request, the license manager 5 requests authentication/authorization of the ST and of the content ID for the respective channels, step 606. The License manager 5 passes the unique ID of the ST 2 and the license request type to OMP 10. On boot, the ST joins the channel data multicast group 53 to retrieve the channel data, step 608, and then joins the IPG data multicast group 52 to retrieve the current IPG data, step 609. Retrieval of the license files will increase boot time to some extent dependent on the size of the license files.

We claim:

1. At an open media platform (OMP) serving a plurality of subscriber terminals connected in a broadcast entertainment system, the broadcast entertainment system being equipped with a license manager for storing generic broadcast licenses, a method of enabling fast access of the subscriber terminals to a license-protected broadcast channel subscribed for, comprising:
a) maintaining at the OMP, a directory with license information specific to each subscriber terminal (ST) served by the OMP;
b) on request from a subscriber terminal to access the license-protected broadcast channel, providing the license manager with the license information for that ST and that channel for enabling the license manager to generate a personalized broadcast license;
c) storing and maintaining at the subscriber terminal, the personalized broadcast license; and
d) decoding the multimedia content carried on the license-protected broadcast channel using the personalized broadcast license, whenever the subscriber terminal requests access to the license-protected broadcast channel,
wherein the personalized broadcast license includes subscription details for the subscriber terminal.

2. The method of claim 1, wherein the license information in the directory is identified by a license identification (L-ID), and the subscriber terminal is identified by a unique ST identification (ST-ID).

3. The method of claim 2, wherein the license information includes license terms for the respective ST-ID and a content identification (C-ID) for identifying a respective multimedia content carried on the license-protected broadcast channel.

4. The method of claim 2, wherein step a) comprises:
updating the directory whenever a new broadcast channel becomes available at the OMP; and
notifying the subscriber terminal of the new broadcast channel for enabling the subscriber terminal to request changes to the personalized broadcast license.

5. The method of claim 3, further comprising updating the directory whenever the ST-ID, the L-ID, the C-ID or the license terms changes.

6. The method of claim 3, further comprising updating the directory whenever the license information changes and notifying the subscriber terminal of the license information change.

7. The method of claim 3, wherein step b) comprises:
receiving from the license manager a request for authentication/authorization for the subscriber terminal to receive the personalized broadcast license;
accessing the directory for authenticating the request based on the ST-ID, and the C-ID;
extracting the license terms corresponding to the ST-ID, the content ID, and the license ID;
providing the license terms to the license manager; and
authorizing the license manager to generate the personalized broadcast license and transmit same to the subscriber terminal.

8. The method of claim 1, executed on initial registration of the subscriber terminal with the OMP, once a new broadcast channel identified by a new C-ID becomes available at the OMP, or once the subscriber terminal requests to join the broadcast channel identified by the C-ID.

9. The method of claim 1, wherein the license terms specify at least one or more of a start/end date, a license term, and a maximum number of times the content identified by the content ID can be accessed.

10. The method of claim 1, further comprising re-issuing the personalized broadcast license on request from the subscriber terminal following a failure or an exception situation.

11. The method of claim 1, wherein the request includes a request type indicating request for a single license or multiple licenses.

12. An open media platform (OMP) for a broadcast entertainment system equipped with a license manager for storing generic broadcast licenses, the OMP for serving a group of subscriber terminals in a geographical area, comprising:
means for transmitting a license-protected broadcast channel subscribed for by one or more subscriber terminals of the group;
a license task for receiving from a license manager an authorization/authentication request specifying that a subscriber terminal wishes to receive the license-protected broadcast channel, and for providing the license manager with the license information for the respective authorization/authentication request; and
a directory with license information specific to each subscriber terminal served by the OMP.

13. An OMP as in claim 12, further comprising an interface for enabling communication with said license manager.

14. The OMP of claim 13, wherein the interface uses HTTP.

15. The OMP of claim 12, wherein the directory comprises for each subscriber terminal identified by a ST-ID the respective license information identified with a license ID, for keeping track of the digital rights of the respective subscriber terminal.

16. The OMP of claim 13, further comprising a second interface with a customer care application available in the broadcast entertainment system for receiving license information regarding subscription details for each subscriber terminal from a customer care application.

17. The OMP of claim 16, wherein the second interface uses the XML or HTTP protocol.

18. The OMP of claim 12, further comprising a third interface with the subscriber terminals for notifying the subscriber terminals of any new services and changes in the license information.

19. The OMP of claim 18, wherein said third interface uses SNMP.

20. For a broadcast entertainment system equipped with a license manager for storing generic broadcast licenses, and with an open media platform (OMP) for serving a group of subscriber terminals in a geographical area, a subscriber terminal comprising:
a decoder for decoding encoded multimedia content received over a set of broadcast channels subscribed for by the subscriber terminal;
a subscriber terminal .nsc process for processing a plurality of locally stored .nsc files, each .nsc file comprising information necessary for accessing and playing a respective broadcast channel of the set;
a subscriber terminal license process for receiving a personalized broadcast license and using same for decoding encoded multimedia content carried on the respective broadcast channel;
a license memory for storing the personalized broadcast license; and
a ST interface for transmitting a request for the personalized broadcast license to the license manager and receiving the personalized broadcast license from the license manager.
